(19) United States
(12) Patent Application Publication
(10) Pub. No.: US 2010/0291263 A1
(43) Pub. Date: Nov. 18, 2010

(54) METHOD OF PREPARING A LOW SODIUM FLOUR-BASED DOUGH WITH IMPROVED HANDLING PROPERTIES

(75) Inventors: Christopher John Morrant, Bromborough (GB); Deborah Mary Kaszuba, Bromborough (GB)

Correspondence Address: FOLEY AND LARDNER LLP;SUITE 500, 3000 K STREET NW, WASHINGTON, DC, 20007, US

(73) Assignee: CSM NEDERLAND B.V.

(21) Appl. No.: 12/738,575

(22) PCT Filed: Oct. 20, 2008
(86) PCT No.: PCT/NL08/50659

§ 371 Date: Jun. 17, 2010

(30) Foreign Application Priority Data
Oct. 18, 2007 (EP) 07118792.6

(51) Int. Cl. A21D 2/02; A21D 10/00; A23L 1/304

(52) U.S. Cl. 426/26; 426/549

(57) ABSTRACT

One aspect of the present invention relates to the use of a sulphate compound to improve the handling properties of a flour-based dough containing a reduced level of sodium. The use of the sulphate compound in accordance with the invention reduces dough stickiness and/or improves dough strength. Examples of suitable sulphate compounds include calcium sulphate, magnesium sulphate, sodiumsulphate, potassium sulphate, ammonium sulphate and sulphuric acid. Another aspect of the invention concerns a method of preparing a low sodium flour based dough, said method being characterized in that (i) the sulphate compound is incorporated in the dough in a concentration of 5-75 mmole per kg of flour, with the proviso that if the sulphate compound is not calcium sulphate, said sulphate component is incorporated in the dough in a concentration of at least 5 mmole per kg of flour and with the proviso that if the sulphate compound is calcium sulphate and if said calcium sulphate is incorporated in a concentration of less than 5 mmole per kg of flour, the method additionally comprises the addition of at least 0.1 mmole of an edible acid per kg of flour, and in that (ii) sodium chloride is incorporated in a concentration of 0-1.6% by weight of cereal ingredients.

### TECHNICAL FIELD OF THE INVENTION

The present invention provides a method of preparing a low sodium flour-based dough with improved handling properties.

Flour-based dough containing reduced levels of sodium can be very sticky and lacking in dough strength, making it difficult or even impossible to handle such dough in bakery equipment. Low sodium dough prepared by the present method ameliorates these defects.

### BACKGROUND OF THE INVENTION

In the human diet salt (sodium chloride) is the main source of sodium. Sodium is essential for life and for good health. It is a mineral that the body cannot manufacture itself so it must be supplied by food. Sodium is readily available from various sources: foods that contain sodium naturally, foods containing salt and other sodium-containing ingredients, and from salt added to foods during cooking and at the table.

As a component of salt, sodium's most recognised role is to make foods more flavourful. Less well-known, yet important roles of sodium-containing ingredients include helping to preserve foods, improving the texture of foods, and ensuring the safety of some foods.

Compared to other minerals, the human body needs sodium in relatively large amounts. Yet, much of the world's population consumes more than the body's minimum requirement for sodium. In some individuals, research suggests a link between high sodium and salt intake and high blood pressure, a major risk factor for heart disease, stroke, and kidney disease. Regulating sodium intake is also believed to be important in preventing and treating other health conditions.

According to the Institute of Medicine (Washington, USA), the daily amount of sodium sufficient to meet the needs of most healthy people, is 1.5 grams per day (3.8 grams of salt) for 19- to 50-year-olds with normal blood pressure. This amount is less than half of the estimated 3.2 grams per day consumed on average by individuals in the United States. The Institute of Medicine also suggests a maximum level for daily sodium consumption, known as the Tolerable Upper Intake Level. For healthy individuals through the age of 50 years, the Tolerable Upper Intake Level is 2.3 grams per day (5.8 grams of salt).

In many countries bread is a staple food product that is consumed in considerable quantities. In the UK a slice of white bread typically contains 0.2 g of sodium. Thus, bread can make a very significant contribution to the total sodium intake of individuals. In the UK where the average person eats the equivalent of 5 slices of bread a day, the sodium intake associated with this bread consumption equates to around 40% of the aforementioned Tolerable Upper Intake Level.

In order to reduce the sodium intake of individuals who tend to consume too much sodium and in order to help individuals who are on a low sodium diet, it would be beneficial to substantially reduce the level of sodium in bread. The sodium level in bread can be lowered by adding less salt to the dough. However, it is found that the properties of the dough are adversely affected by salt reduction. If no salt is added to an ordinary bread dough, the dough will become very sticky and weak, making it very difficult to work and shape the dough.

Consequently, there is a need for a method that enables the preparation of a low sodium flour based dough that can be processed easily in the bakery and that will yield a good quality bread.

### SUMMARY OF THE INVENTION

The inventors have unexpectedly discovered that the aforementioned objective can be realised by replacing at least a part of the sodium chloride used in the preparation of a dough by a sulphate compound (e.g a sulphate salt or sulphuric acid).

Thus, one aspect of the present invention relates to the use of a sulphate compound to improve the handling properties of low sodium flour-based dough. Another aspect of the invention concerns a method of preparing a low sodium flour based dough, said method comprising combining flour, water, a sulphate compound and optionally one or more other bakery ingredients including sodium chloride, said method being characterized in that (i) the sulphate compound is incorporated in the dough in a concentration of 0.5-75 mmole per kg of flour, with the proviso that if the sulphate compound is not calcium sulphate, said sulphate component is incorporated in the dough in a concentration of at least 5 mmole per kg of flour and with the proviso that if the sulphate compound is calcium sulphate and if said calcium sulphate is incorporated in a concentration of less than 5 mmole per kg of flour, the method additionally comprises the addition of at least 0.1 mmole of an edible acid per kg of flour; and in that (ii) sodium chloride is incorporated in a concentration of 0-1.6% by weight of cereal ingredients.

The use of calcium sulphate in flour-based dough is described in U.S. Pat. No. 4,436,758. This US patent describes a dough conditioner containing about 5.067 wt. % calcium sulphate and teaches to employ the dough conditioner in an amount of 0.05% to 0.0625% (baker's percentage).

GB-A 452,483 describes a process of making bakery products which comprises incorporation into the dough of a vanadium compound in an amount equivalent to 2-6 parts by weight and of a bromine compound in an amount of up to 50 parts by weight of flour, fermenting the dough and baking it, the resulting products having a finer, more silky texture with improved colour of crumb. The British patent describes a typical formula of a composition that can be used to introduce a vanadate compound and a bromine compound into dough. This formula also contains ammonium sulphate.

GB-A 2 416 981 describes a method of enriching the mineral content of flour by adding to flour a premix consisting essentially of minerals including at least one source of calcium and a source of vitamin D. In the examples of the British patent application premixes containing magnesium sulphate are described.

### DETAILED DESCRIPTION OF THE INVENTION

One aspect of the present invention relates to the use of a sulphate compound to improve the handling properties of a flour-based dough containing a reduced level of sodium. As explained herein before, the handling properties of the dough are improved in that the sulphate compound reduces dough stickiness and/or improves dough strength.

The term “sulphate compound” as used herein encompasses sulphate salts as well as sulphuric acid. The sulphate salts can be both anhydrous and hydrated.

The terminology “reduced level of sodium” refers to a sodium content that is substantially lower than the sodium content usually employed in a given type of dough.

The benefits of the present invention are particularly manifest if the sulphate compound is used in a dough with a significantly reduced sodium content, e.g. a dough containing not more than 0.6% of sodium by weight of cereal ingredients selected from the group consisting of flour, whole grains, grain components and mixtures thereof. Even more preferably, the dough contains not more than 0.3% of sodium by weight of cereal ingredients selected from the group consisting of flour, whole grains, grain components and mixtures thereof. According to another preferred embodiment, the dough contains not more than 0.6% of sodium by weight of flour, even more preferably not more than 0.3% sodium by weight of flour.

The inventors have found that best results are obtained if not all of the sodium is removed from the dough. Consequently, in accordance with a particularly preferred embodiment, the dough contains at least 0.08%, even more preferably at least 0.12% of sodium by weight of flour.

Another aspect of the present invention relates to method of preparing a low sodium flour based dough, said method comprising combining flour, water, a sulphate compound and optionally one or more other bakery ingredients including sodium chloride, said method being characterized in that:
the sulphate compound is incorporated in the dough in a concentration of 0.5-75 mmole per kg of flour, with the proviso that if the sulphate compound is not calcium sulphate, said sulphate component is incorporated in the dough in a concentration of at least 5 mmole per kg of flour and with the proviso that if the sulphate compound is calcium sulphate and if said calcium sulphate is incorporated in a concentration of less than 5 mmole per kg of flour, the method additionally comprises the addition of at least 0.1 mmole of an edible acid per kg of flour;
sodium chloride is incorporated in a concentration of 0-1.6% by weight of cereal ingredients selected from the group consisting of flour, whole grains, grain components and mixtures thereof.

Although the inventors do not wish to be bound by theory, it is believed that beneficial effect of the sulphate compound on dough handling is correlated with the amount of dissociated sulphate that is delivered by said compound in the dough. This hypothesis is based on the observation that the advantageous effect on dough handling properties of sulphate compounds with poor water solubility, when used in limited quantities, can be enhanced by addition of an edible acid.

Calcium sulphate is an example of a poorly water-soluble sulphate salt that usually needs to be incorporated in a concentration of at least 5 mmole per kg of flour to generate a significant improvement of the dough handling properties. If however, edible acid is added, e.g. in an amount of at least 0.1 mmole per kg of flour, significantly smaller amount of calcium sulphate can be used to achieve the same effect. It will be understood that the amount of acid that is needed to achieve significant dissociation of the calcium sulphate depends on both the nature of the acid (weak or strong) and the compositions of the dough (presence of buffering components). According to a preferred embodiment, edible acid is incorporated in the dough in an amount of at least 0.2 mmole per kg of flour, more preferably of at least 0.4 mmole per kg of flour.

Examples of flour based dough in which the benefits of the present invention can be realised include bread dough, pizza dough, bun doughs, croissant dough, brioche dough, doughnut dough and Berliner dough. Preferably, the flour based dough is a bread dough, a pizza dough or a bun dough. Even more preferably, the flour based dough is a bread dough. Most preferably, the dough is a leavened bread dough containing 50-65 wt. % of flour and 30-45 wt. % of water.

Advantageously, the sulphate compound is incorporated in the dough in an amount of at least 2 mmole per kg of flour, even more preferably in an amount of at least 5 mmole per kg of flour and most preferably in an amount of at least 10 mmole per kg of flour.

Advantageously, the sulphate compound employed in accordance with the present invention is selected from the group consisting of calcium sulphate, magnesium sulphate, sodium sulphate, potassium sulphate, ammonium sulphate, sulphuric acid and combinations thereof. Even more preferably, the sulphate compound is selected from the group consisting of calcium sulphate, magnesium sulphate, potassium sulphate, ammonium sulphate and combinations thereof, calcium sulphate being most preferred.

In accordance with one preferred embodiment, the calcium sulphate is employed in a concentration of at least 5 mmole, more preferably of at least 10 mmole, most preferably of at least 20 mmole per kg of flour.

According to another preferred embodiment, the calcium sulphate is incorporated into the dough together with at least 0.1 mmole of an edible acid by weight of flour. Examples of edible acids that may suitably be employed include: citric, malic, acetic, fumaric, tartaric, phosphoric, adipic, lactic, ascorbic, sorbic, propionic, erythorbic, sulfuric and hydrochloric acids. In accordance with a particularly advantageous embodiment of the present method, calcium sulphate and edible acid are incorporated in the dough in a molar ratio of least 1:20, preferably of at least 1:10 and most preferably of at least 1:5. Typically, this molar ratio does not exceed 20:1, most preferably it does not exceed 10:1.

According to a particularly preferred embodiment, the sulphate compound is selected from the group consisting of anhydrous calcium sulphate (CaSO₄), calcium sulphate hemihydrate (CaSO₄.˜0.5H₂O), calcium sulphate dehydrate (CaSO₄.2H₂O) and combinations thereof. Most preferably the calcium sulphate employed in accordance with the present invention is (CaSO₄.2H₂O).

It will be understood that in order to achieve a low sodium content in the dough, addition of sodium chloride should be minimised. Typically, in the present method sodium chloride is added during dough preparation in a concentration of not more than 1.2%, even more preferably of not more than 1.0% and most preferably of not more than 0.75% percentage by weight of cereal ingredients selected from the group consisting of flour, whole grains, grain components and mixtures thereof,

In accordance with another embodiment, not more than 1.6%, preferably not more than 1.2%, even more preferably not more than 1.0% and most preferably not more than 0.75% by weight of flour of sodium chloride is added during dough preparation.

As explained herein before, it is advantageous not to remove all sodium from the low sodium dough. In order to ensure that the dough contains a beneficial amount of sodium, it is advantageous to add at least 0.2%, more preferably at least 0.3% of sodium chloride by weight of flour during dough preparation.

The benefits of the present invention are particularly noticeable in bakery products containing not more than limited amounts of sugar (sucrose). Accordingly, in the present method preferably not more than 8% of sucrose by weight of flour is incorporated in the dough. Even more preferably, not more than 4%, most preferably not more than 0.3% of sucrose by weight of flour is incorporated during the manufacture of the low sodium dough.

It is known in the bakery art to include gelling polymers such as alginate and pectin in dough and to incite gelation of these gelling polymers through addition of multivalent metal cations, notably calcium. The use of such gelling polymers in the present low sodium dough may not be beneficial. Accordingly, in a preferred embodiment, not more than 0.5%, even more preferably not more than 0.1% by weight of flour of a gelling polymer selected from the group consisting of alginate, pectin and combinations thereof is incorporated in the dough.

The present method is particularly suitable for preparing leavened dough. Accordingly, the present method preferably comprises the step of leavening the dough to obtain a leavened dough have a specific volume of at least 2 ml/g, even more preferably of at least 3 ml/g and most preferably of at least 4 ml/g. The dough may be leavened with the help of yeast or a chemical leavening agent. Most preferably, the present method comprises the incorporation of live yeast.

The sulphate compound employed in accordance with the present invention is preferably incorporated in the dough in the form of a particulate composition containing at least 1 wt. %, more preferably at least 5 wt. %, even more preferably at least 10 wt. % and most preferably at least 20 wt. % of the sulphate compound.

The aforementioned particulate composition preferably is a free flowing composition wherein at least 80 wt. % of the composition has a particle size within the range of 50-300 μm, even more preferably within the range of 75-150 μm.

The aforementioned particulate composition may suitably contain one or more bakery ingredients besides the sulphate compound. Examples of bakery ingredients that may advantageously be incorporated in the particulate composition include gluten, starches, cereal flours, sugars, acids, emulsifiers, fats, hydrocolloids, oxidants, reducing agents, flavouring compounds and enzyme preparations, and combinations thereof.

Advantageously, the particulate composition contains at least 0.1 wt. % of one or more of the aforementioned bakery ingredients.

Yet another aspect of the present invention relates to a flour based dough obtained or obtainable by a method as described herein before.

The invention is further illustrated by means of the following examples.

### EXAMPLES

### Example 1

White bread dough was prepared according to 5 different recipes using the Chorleywood bread process. The recipes that were tested are depicted in Table 1.

TABLE 1
(amounts in parts per weight)

| | Control | A | B | C | D |
|---|---|---|---|---|---|
| White flour | 100 | 100 | 100 | 100 | 100 |
| Bread improver | 1.5 | 1.5 | 1.5 | 1.5 | 1.5 |
| NaCl | 1 | 1 | 1 | 1 | 1 |
| Yeast | 3.2 | 3.2 | 3.2 | 3.2 | 3.2 |
| Water | 59.5 | 59.5 | 57.5 | 58.3 | 59.4 |
| CaSO₄•2H₂O | | 1 | | | |
| Premix of CaSO₄•2H₂O in | | | 3 | | |
| water (1:2) | | | | | |
| Premix of CaSO₄•2H₂O in | | | | 2.25 | |
| 12% vinegar (4:5) | | | | | |
| Sulphuric acid solution (5M) | | | | | 0.1 |

The calcium sulfate (Ground Gypsum Superfine White) used in the experiments was purchased from BPB Formula, Newalk, United Kingdom. The calcium sulfate had a solubility in water at 20° C. of 2.1 g/litre. The particle size distribution of the calcium sulfate powder according to the specification was as follows:

| | % by weight retained |
|---|---|
| 300 μm sieve | 0.2% max |
| 150 μm sieve | 1.0% |
| 75 μm sieve | 12% |

86% by weight of the particles has a particle size <75 μm

The handling properties of the doughs were evaluated by expert bakers. It was found that the dough handling properties of doughs A, B, C and D were clearly superior to these of the control dough. In particular it was found that the control dough was much more sticky and weaker than the other doughs. It was further observed that the use of vinegar enhanced the advantageous impact of the calcium sulphate on the dough handling properties.

### Example 2

With bread dough was made using the two different recipes depicted in Table 2.

TABLE 2
(amounts in parts per weight)

| | Control | A |
|---|---|---|
| Breadmaking Flour | 100.00 | 100.00 |
| Water | 61.00 | 61.00 |
| Yeast | 2.70 | 2.70 |
| Salt | 1.00 | 1.00 |
| CaSO₄•2H₂O | 0.00 | 1.00 |
| Diamond ® dough conditioner^{#} | 1.25 | 1.25 |
| Vinegar (12% spirit) (as an example | 1.25 | 1.25 |
| of an acid) | | |

^{#}ex Bakemark, United Kingdom

The dough mixes were prepared by mixing the ingredients on a Tweedy style mixer to 10 Wh/kg. The final dough temperature of 29.5° C. was achieved after approximately 170 seconds of mixing. Next, the dough was proved for 55 minutes at 45° C. and 70% relative humidity. The proved dough was subsequently baked at 200-220° C. for approximately 23 minutes to yield bread loaves having a golden brown crust.

The handling properties of the doughs were evaluated by taking 480 gram of the dough from the mix after 10 minutes rest time. Bakers assessed the adhesion of these dough pieces to their hands during handling. In addition, the consistency of the dough pieces was measured with the help of a Farinograph, using 180 seconds of mixing.

The evaluation of the manual handling showed that the addition of calcium sulphate reduced stickiness and enhances dough strength. This finding was confirmed by the Farinograph results that indicate that the use of calcium sulphate increases the consistency of the dough by 25-30 Brabender Units. The evaluation of the baked breads (appearance, taste and texture) did not show any substantial differences between the two products.

1.-19. (canceled)

20. A method of preparing a low sodium flour-based dough, the method comprising combining:
(A) flour as a first cereal ingredient, and optionally, a second cereal ingredient selected from the group consisting of whole grains, grain components and mixtures thereof,
(B) sodium chloride at a concentration of 0-1.6% by weight of cereal ingredient,
(C) water,
(D) and a sulphate compound, wherein:
(a) the sulphate compound is incorporated at a concentration of 5-75 mmole per kg of flour and the sulphate compound is not calcium sulphate, or
(b) the sulphate compound is calcium sulphate and:
(i) is incorporated at a concentration of 5-75 mmole per kg of flour; or
(ii) is incorporated at a concentration of at least 0.5 mmole per kg of flour and less than 5 mmole per kg of flour with at least 0.1 mmole of an edible acid per kg of flour
to form a dough.

21. The method of claim 20 wherein sodium chloride is added at a concentration of 0-1.2% by weight of cereal ingredient.

22. The method according to claim 21, wherein sodium chloride is added at a concentration of 0-1.0% by weight of cereal ingredient.

23. The method according to claim 22, wherein sodium chloride is added at a concentration of 0-0.75% by weight of cereal ingredient.

24. The method according to claim 20, wherein sodium chloride is added at a concentration of 0-1.6% by weight of flour.

25. The method according to claim 24, wherein sodium chloride is added at a concentration of 0-1.2% by weight of flour.

26. The method according to claim 25, wherein sodium chloride is added at a concentration of 0-1.0% by weight of flour.

27. The method according to claim 26, wherein sodium chloride is added at a concentration of 0-0.75% by weight of flour

28. The method according to claim 20, wherein sodium chloride is added at a concentration of at least 0.2% by weight of flour.

29. The method according to claim 28, wherein sodium chloride is added at a concentration of at least 0.3% by weight of flour.

30. The method according to claim 20, wherein the sulphate compound is selected from the group consisting of calcium sulphate, magnesium sulphate, sodium sulphate, potassium sulphate, ammonium sulphate, sulphuric acid and combinations thereof.

31. The method according to claim 20, wherein the sulphate compound is calcium sulphate.

32. The method according to claim 31, wherein the calcium sulphate is incorporated in the dough in a concentration of at least 0.5 mmole per kg of flour.

33. The method according to claim 31, wherein at least 0.1 mmole of edible acid is incorporated in the dough.

34. The method according to claim 20, further comprising leavening the dough to obtain a leavened dough having a specific volume of at least 2 ml/g.

35. The method of claim 34, wherein the leavened dough is comprises 50-65 wt. % of flour and 30-45 wt. % of water.

36. The method according to claim 20, wherein the sulphate compound is incorporated in the form of a particulate composition containing at least 5 wt. % of calcium sulphate.

37. A method of improving the handling properties of hour-based dough having a reduced level of sodium, the method comprising adding to the dough a sulphate compound.

38. The method of claim 37, wherein the dough comprises a cereal ingredient selected from the group consisting of flour, whole grains, grain components and mixtures thereof.

39. The method of claim 37, wherein the dough comprises not more than 0.6% of sodium by weight of cereal ingredient.

40. The method of claim 37, wherein the dough contains 0.12-0.6% of sodium by weight of flour.

41. A flour-based dough obtained by the method according to claim 20.

42. A flour-based dough comprising:
(A) flour as a first cereal ingredient, and optionally, a second cereal ingredient selected from the group consisting of whole grains, grain components and mixtures thereof,
(B) water,
(C) a sulphate compound, wherein:
(a) the sulphate compound is at a concentration of 5-75 mmole per kg of flour and the sulphate compound is not calcium sulphate, or
(b) the sulphate compound is calcium sulphate and:
(i) is at a concentration of 5-75 mmole per kg of flour; or
(ii) is at a concentration of at least 0.5 mmole per kg of flour and less than 5 mmole per kg of flour with at least 0.1 mmole of an edible acid per kg of flour; and,
(D) optionally, added sodium chloride, an edible acid, or both.
